(19) United States
(12) Patent Application Publication
(10) Pub. No.: US 2026/0119910 A1
(43) Pub. Date: Apr. 30, 2026

(54) ON-DEVICE PERSONALIZATION BASED ON DETECTED USER STATE AND PREDICTED USER INTENT

(71) Applicant: QUALCOMM Incorporated, San Diego, CA (US)

(72) Inventors: Diyan TENG, Sunnyvale, CA (US); Mehul SOMAN, San Jose, CA (US); Junsheng HAN, Los Altos Hills, CA (US)

(21) Appl. No.: 18/933,779

(22) Filed: Oct. 31, 2024

(51) Int. Cl. G06N 5/022

(52) U.S. Cl. CPC G06N 5/022

(57) ABSTRACT

In some aspects, a device may obtain a set of observations, wherein each observation in the set of observations includes a set of features associated with one or more sensor signals. The device may detect a user state at a current time based on the set of observations. The device may predict a user intent in a future window based on the set of observations. The device may send a message over a network to request a service based on the user state at the current time and the user intent in the future window satisfying one or more conditions associated with the service. Numerous other aspects are described.

### FIELD OF THE DISCLOSURE

Aspects of the present disclosure generally relate to on-device personalization and, for example, to using on-device artificial intelligence and/or machine learning (AI/ML) capabilities to detect a user state and/or to predict a user intent that may be used by one or more applications running on the device.

### BACKGROUND

Sensors are becoming increasingly prevalent in consumer electronics, allowing greater personalization, convenience, and user experience. For example, consumer electronics such as smartphones and wearable devices may be equipped with sensors such as accelerometers, gyroscopes, barometers, and proximity sensors, among others, that can capture data related to user activities, environmental context, and device interactions.

### SUMMARY

Some aspects described herein relate to a method for on-device personalization performed by a device. The method may include obtaining a set of observations, wherein each observation in the set of observations includes a set of features associated with one or more sensor signals. The method may include detecting a user state at a current time based on the set of observations. The method may include predicting a user intent in a future window based on the set of observations. The method may include sending a message over a network to request a service based on the user state at the current time and the user intent in the future window satisfying one or more conditions associated with the service.

Some aspects described herein relate to a device. The device may include one or more memories and one or more processors coupled to the one or more memories. The one or more processors may be configured to obtain a set of observations, wherein each observation in the set of observations includes a set of features associated with one or more sensor signals. The one or more processors may be configured to detect a user state at a current time based on the set of observations. The one or more processors may be configured to predict a user intent in a future window based on the set of observations. The one or more processors may be configured to send a message over a network to request a service based on the user state at the current time and the user intent in the future window satisfying one or more conditions associated with the service.

Some aspects described herein relate to a non-transitory computer-readable medium that stores a set of instructions by a device. The set of instructions, when executed by one or more processors of the device, may cause the device to obtain a set of observations, wherein each observation in the set of observations includes a set of features associated with one or more sensor signals. The set of instructions, when executed by one or more processors of the device, may cause the device to detect a user state at a current time based on the set of observations. The set of instructions, when executed by one or more processors of the device, may cause the device to predict a user intent in a future window based on the set of observations. The set of instructions, when executed by one or more processors of the device, may cause the device to send a message over a network to request a service based on the user state at the current time and the user intent in the future window satisfying one or more conditions associated with the service.

Some aspects described herein relate to an apparatus. The apparatus may include means for obtaining a set of observations, wherein each observation in the set of observations includes a set of features associated with one or more sensor signals. The apparatus may include means for detecting a user state at a current time based on the set of observations. The apparatus may include means for predicting a user intent in a future window based on the set of observations. The apparatus may include means for sending a message over a network to request a service based on the user state at the current time and the user intent in the future window satisfying one or more conditions associated with the service.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which on-device personalization based on a detected user state and a predicted user intent may be implemented, in accordance with the present disclosure.

FIG. 2 is a diagram illustrating example components of a device, in accordance with the present disclosure.

FIG. 3 is a diagram illustrating an example architecture associated with an inferencing system that may support on-device personalization based on a detected user state and a predicted user intent, in accordance with the present disclosure.

FIG. 4 is a diagram illustrating an example inferencing flow that may support on-device personalization based on a detected user state and a predicted user intent, in accordance with the present disclosure.

FIG. 5 is a diagram illustrating an example use case associated with an inferencing system that may support on-device personalization based on a detected user state and a predicted user intent, in accordance with the present disclosure.

FIG. 6 is a diagram illustrating an example of multi-step prediction based on a set of ground truth observations, in accordance with the present disclosure.

FIG. 7 is a diagram illustrating an example associated with training and using an artificial intelligence and/or machine learning model in connection with on-device personalization based on a detected user state and a predicted user intent, in accordance with the present disclosure.

FIG. 8 is a flowchart of an example process associated with on-device personalization based on a detected user state and a predicted user intent, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Personalization technologies are generally designed to deliver user experiences through features that are adapted or tailored to user behavior patterns and preferences. For example, personalization technologies typically collect and interpret sensory context data, such as physical activity, geographical locations, environmental audio cues, application usage patterns, and/or browsing histories, among other examples, to tailor device functionality and content accordingly. However, despite the advancements in personalization technologies, there remains a challenge in leveraging sensory data and other user context information to preemptively or proactively identify and understand situations where a user intends to engage in an activity that is incompatible or in conflict with capabilities that the user has in a current physical state. For example, despite the robust sensory and context data available on modern electronic devices, personalization technologies fall short in providing interventions to address safety-critical situations, such as instances where a user may be physically incapacitated or have an impaired decision-making ability. Furthermore, in cases where a user engages in behaviors that significantly impair judgment or motor functions, such as consuming alcohol, the user may not be in a state, or willing, to request assistance.

The inability to recognize complex behavioral patterns that indicate when a user may intend to engage in an activity while in a particular state may present personal and/or public safety risks, particularly in scenarios where the impaired user is expected to operate complex machinery or engage in activities that demand coordination and awareness, such as driving. Traditional mechanisms to detect and respond to such user states and/or user intents typically occur post-incident or rely on the user having the capacity to recognize and address their own impairment, which can be unreliable. Furthermore, personalization technologies are typically designed to enhance device interactions, such as providing voice assistants, recommending content, controlling smart home devices, and/or improving autocorrect accuracy or text predictions, rather than preemptively offering assistance or intervention in a way that respects user autonomy and privacy. Accordingly, personalization technologies fall short in analyzing and interpreting multi-modal sensor data and/or formulating predictive behavioral models that can anticipate user needs and potential safety risks without intrusive monitoring or decision-making solely reliant on user self-assessments.

Various aspects relate generally to on-device personalization techniques that utilize real-time sensor data and other on-device and/or external context sources to predict a user intent and detect a user state, and to offer preemptive assistance when the predicted user intent and the detected user state satisfy one or more conditions (e.g., one or more conditions that indicate a safety-critical situation, such as an intent to drive while impaired or intoxicated). Some aspects more specifically relate to techniques to obtain observations from the on-device and/or external context sources and learn user demographics, habits, interests, behaviors, patterns, and/or other attributes over time, and use the observations to build a personalized knowledge graph that can then be used to detect or infer a current user state and to predict a user intent in a future forecasting window based on additional observations from the on-device and/or external context sources. Accordingly, when the detected user state and the predicted user state satisfy one or more conditions, appropriate actions may be initiated. For example, the device may send a message to request a service (e.g., a designated driver service) if the current user state and the predicted future intent satisfy one or more conditions (e.g., the user is in an impaired or intoxicated state and has the intent to drive). Furthermore, some aspects described herein relate to techniques to integrate feedback loops based on additional sensor observations to confirm or modify artificial intelligence or machine learning (AI/ML) beliefs regarding the user state or the user intent (e.g., one or more AI/ML models may be updated based on whether an observation is consistent with or conflicts with a predicted intent or user state).

Particular aspects of the subject matter described in this disclosure can be implemented to realize one or more of the following potential advantages. In some examples, by leveraging sensor data efficiently to detect user states and predict future intents, some aspects described herein may enable preemptive actions to ensure optimal device functionality and/or user safety in certain scenarios. For instance, some aspects described herein may autonomously initiate service requests, such as requesting a designated driver, by analyzing sensor data and user context in real-time. In this way, a preemptive or proactive approach to respond to a user state and future intent reduces a dependence on manual user inputs and/or conserves processing and/or communication resources by initiating preemptive action only when certain conditions are satisfied. Furthermore, by using on-device AI/ML capabilities to detect the user state and predict the user intent, some aspects described herein reduce response times and increase user privacy, and conserve network resources by avoiding cloud-based analytics. Some aspects may further conserve memory resources through retaining only enough historical and real-time data for accurate state detection and intent prediction. Furthermore, some aspects described herein may support various services or device actions beyond safety interventions, enabling on-device personalization in any suitable scenario where observations associated with on-device and/or external sources can be employed to deliver timely and automated assistance to a user according to a user state and a user intent at a given moment in time.

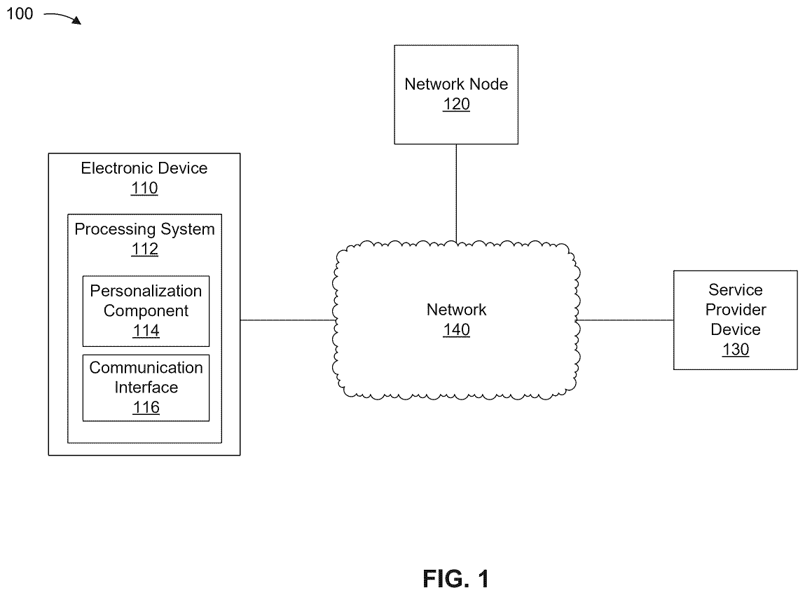

FIG. 1 is a diagram illustrating an example environment in which on-device personalization based on a detected user state and a predicted user intent may be implemented, in accordance with the present disclosure. As shown in FIG. 1, the environment 100 may include an electronic device 110, a network node 120, and a service provider device 130, that may communicate with one another via a network 140. The electronic device 110, the network node 120, and the service provider device 130 may be dispersed throughout the network 140, and the electronic device 110, the network node 120, and the service provider device 130 may each be stationary and/or mobile. The network 140 may include wired connections, wireless connections, or a combination of wired and wireless connections to enable communication among the electronic device 110, the network node 120, and the service provider device 130.

The electronic device 110 includes one or more devices capable of providing on-device personalization based on a detected user state and a predicted user intent. For example, the electronic device 110 may include a wired and/or wireless communication and/or computing device, such as a user equipment (UE), a mobile phone (e.g., a smart phone, a radiotelephone, and/or the like), a laptop computer, a tablet computer, a handheld computer, a desktop computer, a gaming device, a wearable communication device (e.g., a smart wristwatch or a pair of smart eyeglasses), or the like.

The network node 120 may include one or more devices capable of receiving, processing, storing, routing, and/or providing traffic (e.g., a packet and/or other information or metadata) in a manner described herein. For example, the network node 120 may include a router, such as a label switching router (LSR), a label edge router (LER), an ingress router, an egress router, a provider router (e.g., a provider edge router or a provider core router), a virtual router, or another type of router. Additionally, or alternatively, the network node 120 may include a gateway, a switch, a firewall, a hub, a bridge, a reverse proxy, a server (e.g., a proxy server, a cloud server, or a data center server), a load balancer, and/or a similar device. Additionally, or alternatively, the network node 120 may include a base station (a Node B, an eNB, and/or a gNB, among other examples), a relay device, a network controller, an access point, a transmit receive point (TRP), an apparatus, a device, a computing system, one or more components of any of these, and/or another processing entity configured to perform one or more aspects of the techniques described herein. For example, the network node 120 may be an aggregated base station and/or one or more components of a disaggregated base station (e.g., a central unit (CU), a distributed unit (DU), and/or a radio unit (RU), also known as a remote radio unit (RRU) or remote radio head (RRH)). In some aspects, the network node 120 may be a physical device implemented within a housing, such as a chassis. In some aspects, the network node 120 may be a virtual device implemented by one or more computing devices of a cloud computing environment or a data center. In some aspects, a group of network nodes 120 may be a group of data center nodes that are used to route traffic flow through a network.

The service provider device 130 includes one or more devices capable of providing services related to a user state and/or a user intent associated with the electronic device. For example, the service provider device 130 may include a wired and/or wireless communication and/or computing device, such as a UE, a mobile phone (e.g., a smart phone, a radiotelephone, and/or the like), a laptop computer, a tablet computer, a handheld computer, a desktop computer, a gaming device, a wearable communication device (e.g., a smart wristwatch or a pair of smart eyeglasses), or the like. Additionally, or alternatively, the service provider device 130 may include a server, such as an application server, a client server, a web server, a database server, a host server, a proxy server, a virtual server (e.g., executing on computing hardware), or a server in a cloud computing system. In some aspects, the service provider device 130 may include computing hardware used in a cloud computing environment.

The network 140 includes one or more wired and/or wireless networks. For example, the network 140 may include a cellular network (e.g., a code division multiple access (CDMA) network, a 3G network, a 4G network, a 5G network, a 6G network, or another type of next generation network, or the like), a public land mobile network (PLMN), a local area network (LAN) or a wireless LAN (WLAN), a wide area network (WAN) or a wireless WAN (WWAN), a personal area network (PAN) or a wireless PAN (WPAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

As shown, the electronic device may include a processing system 112. The processing system 112 may include one or more components (or subcomponents), such as a personalization component 114, a communication interface 116, and/or one or more other components described herein. For example, a component of the processing system 112 may be, be similar to, include, or be included in at least one memory, at least one communication interface, or at least one processor. The processing system 112 may generally correspond to a system that includes one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, as shown in FIG. 1, the processing system 112 may include the personalization component 114, which may be configured to perform one or more tasks or operations described herein. In some aspects, the personalization component 114 may direct the communication interface 116 to perform one or more communication tasks as described herein. Although depicted with reference only to the electronic device 110, any one or more of the network node 120 and/or the service provider device 130 may include a communication interface.

As used herein, the communication interface 116 may be any suitable interface that enables communication (e.g., wireless communication, wired communication, or a combination thereof) between the electronic device 110 and another entity or device, such as the network node 120 and/or the service provider device 130. The communication interface 116 may include electronic circuitry that enables the electronic device 110 to transmit, receive, or otherwise perform the communication. For example, the communication interface 116 may include a transmission component, a reception component, and/or a transceiver configured to communicate with other devices, such as via a wired connection, a wireless connection, or a combination of wired and wireless connections. In some examples, the communication interface 116 may include one or more RF components, an RF front end, one or more antennas, one or more transmit or receive processors, a demodulation component, and/or a modulation component, among other examples. In some examples, the communication interface 116 may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

As described in more detail elsewhere herein, the electronic device 110 may (e.g., the processing system 112 may, or the processing system 112 may cause the personalization component 114 and/or the communication interface 116) to obtain a set of observations, wherein each observation in the set of observations includes a set of features associated with one or more sensor signals; detect a user state at a current time based on the set of observations; predict a user intent in a future window based on the set of observations; and send a message over a network to request a service based on the user state at the current time and the user intent in the future window satisfying one or more conditions associated with the service. Additionally, or alternatively, the electronic device 110 and/or the personalization component 114 may perform one or more other operations described herein.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

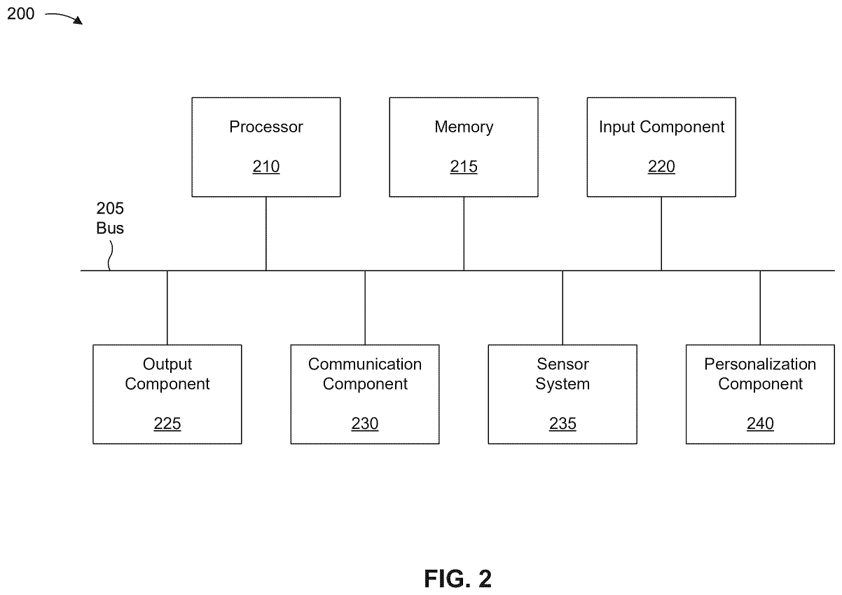

FIG. 2 is a diagram illustrating example components of a device 200, in accordance with the present disclosure. The device 200 may correspond to electronic device 110, network node 120, and/or service provider device 130. In some aspects, electronic device 110, network node 120, and/or service provider device 130 may include one or more devices 200 and/or one or more components of the device 200. As shown in FIG. 2, the device 200 may include a bus 205, a processor 210, a memory 215, an input component 220, an output component 225, a communication component 230, a sensor system 235, and/or a personalization component 240.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna.

The sensor system 235 includes one or more wired or wireless devices capable of receiving, generating, storing, transmitting, processing, detecting, and/or providing information associated with a state of the device 200 and/or an environment surrounding the device 200, as described elsewhere herein. For example, the sensor system 235 may include a motion sensor, an accelerometer, a gyroscope, an inertial measurement unit (IMU), a proximity sensor, a light sensor, a noise sensor, a pressure sensor, an ultrasonic sensor, a positioning sensor, a capacitive sensor, a timing device, an infrared sensor, an active sensor (e.g., a sensor that uses external power), a passive sensor (e.g., a sensor that does not need external power), a biological or biometric sensor, a smoke sensor, a gas sensor, a chemical sensor, an alcohol sensor, a temperature sensor, a moisture sensor, a humidity sensor, a radioactive sensor, a magnetometer, a hall sensor, an electromagnetic sensor, an analog sensor, and/or a digital or virtual sensor (e.g., a software-based sensor, or algorithm, that gathers data from one or more physical hardware sensors and generates an intended sensor output), among other examples. The sensor system 235 may sense or detect a condition or information related to a state of the device 200 and/or an environment surrounding the device 200 and transmit, using a wired or wireless communication interface, an indication of the detected condition or information to other components of the device 200 and/or other devices.

The personalization component 240 includes one or more devices capable of receiving, generating, storing, transmitting, processing, detecting, and/or providing on-device personalization based on a detected user state and/or a predicted user intent, as described elsewhere herein. For example, in some aspects, the personalization component 240 may obtain a set of observations, wherein the set of observations each include a set of features associated with one or more sensor signals (e.g., output by the sensor system 235); detect a user state at a current time based on the set of observations; predict a user intent in a future window based on the set of observations; and send a message over a network to request a service based on the user state at the current time and the user intent in the future window satisfying one or more conditions associated with the service. Additionally, or alternatively, the personalization component 240 may perform other operations described herein.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, the device 200 may include means for obtaining a set of observations, wherein each observation in the set of observations includes a set of features associated with one or more sensor signals; means for detecting a user state at a current time based on the set of observations; means for predicting a user intent in a future window based on the set of observations; and/or means for sending a message over a network to request a service based on the user state at the current time and the user intent in the future window satisfying one or more conditions associated with the service. In some aspects, the means for the device 200 to perform processes and/or operations described herein may include one or more components of the device 200 described in connection with FIG. 2, such as bus 205, processor 210, memory 215, input component 220, output component 225, communication component 230, and/or sensor system 235, among other examples.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

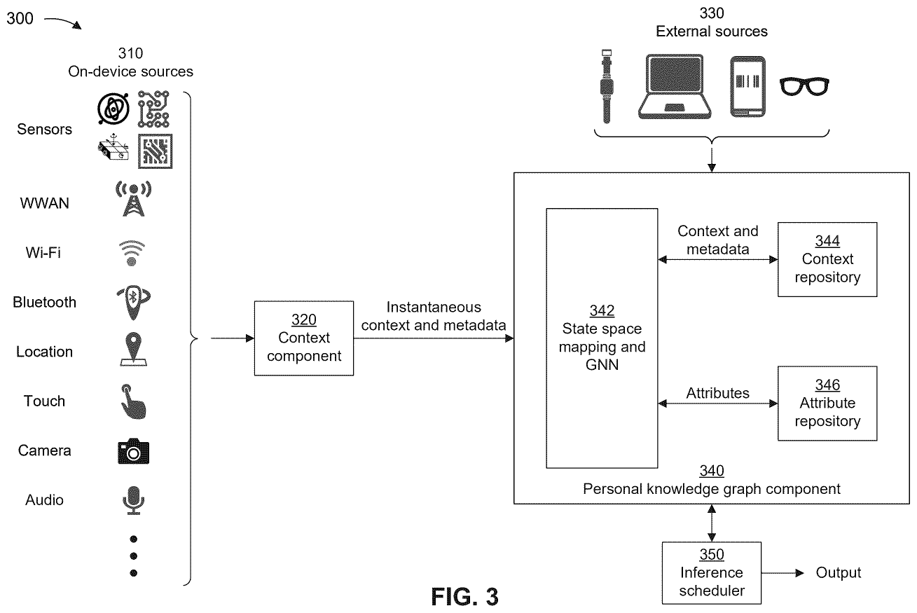

FIG. 3 is a diagram illustrating an example architecture 300 associated with an inferencing system that may support on-device personalization (ODP) based on a detected user state and/or a predicted user intent, in accordance with the present disclosure. More particularly, as described herein, the inferencing system may utilize one or more AI/ML models and data stored locally on an electronic device (e.g., electronic device 110) to tailor one or more applications, services, and/or features to an individual user. For example, the architecture 300 may enable contextual inferencing based on passive sensing, which may be used to develop a knowledge base that encodes or otherwise represents demographics, habits, interests, behaviors, and/or attributes associated with a user. Accordingly, the knowledge base associated with a user can be used to enhance functionality associated with one or more downstream applications.

For example, as shown in FIG. 3, the inferencing system may receive inputs from various on-device sources 310, which may include a sensing hub or sensing system with various physical sensors or hardware-based sensors that can measure specific environmental properties. For example, in some aspects, the physical sensors may include an inertial measurement unit (IMU) (e.g., including an accelerometer, gyroscope, magnetometer, and/or other sensors), a temperature sensor, a proximity sensor, an ambient light sensor, a pressure sensor, a humidity sensor, an ambient temperature sensor, a Hall sensor, and/or a capacitive proximity sensor, among other examples. Accordingly, the physical sensors can be used to gather data related to parameters such as acceleration, magnetic field, pressure, humidity, ambient light, angular velocity, rotation rate, temperature, and/or object proximity, among other examples.

As further shown in FIG. 3, the on-device sources 310 may include one or more connectivity sources that may measure or generate information related to device usage and/or connectivity on one or more WWANs (e.g., 5G, 6G, or other cellular networks), one or more WLANs (e.g., Wi-Fi networks), one or more WPANs (e.g., Bluetooth networks), and/or other suitable networks (e.g., Ethernet or wired networks, or other wireless network types). For example, the on-device connectivity sources may provide WWAN communication parameters such as signal strength or signal quality, network node locations and/or identifiers, WWAN types (e.g., 4G, 5G, or 6G), data usage patterns, and/or roaming status, WLAN parameters such as signal strength and stability, WLAN network identifiers, frequency bands (e.g., 2.4 gigahertz (GHz) versus 5 GHz), connection durations and/or patterns, and network congestion, and/or WPAN parameters such as device proximity, paired device types and usage, connection patterns, Bluetooth versions, and/or signal strength, among other examples.

As further shown in FIG. 3, the on-device sources 310 may include various additional sources, such as a location information source that may indicate visited locations and associated data such as timestamps, a touch information source that may indicate parameters such as grip styles and touch pressure levels, a camera information source that may indicate facial recognitions, frequently captured faces or scenes, and/or preferred camera settings, and/or an audio information source that may indicate parameters such as ambient noise, voice requests or commands, and/or noise patterns. Furthermore, although FIG. 3 illustrates on-device sources 310 that include physical sensors, connectivity sources, and various additional sources, the on-device sources 310 may include additional sources and/or fewer sources than shown in FIG. 3, depending on an implementation associated with a particular electronic device.

As further shown in FIG. 3, information gathered by the various on-device sources 310 may be provided to a context component 320, which may analyze the information gathered by the various on-device sources 310 in real-time to determine an instantaneous context and related metadata associated with the electronic device. In some aspects, the context component 320 may generally execute one or more algorithms to evaluate the information gathered by the various on-device sources 310 to generate contextual information and metadata that may provide more meaningful and/or actionable data for on-device personalization. For example, in some aspects, the context component 320 may execute one or more algorithms to evaluate inputs from physical sensors, which may be used to detect absolute motion (e.g., reporting that the electronic device is either stationary or in motion), relative motion (e.g., a motion that is significant with respect to gravity), or significant motion (e.g., a motion that might lead to a change in location, such as walking, biking, or sitting in a moving vehicle). Furthermore, the context component 320 may execute other suitable algorithms to evaluate the inputs from the physical sensors, such as algorithms for a pedometer, step detection, tilt detection, tilt-to-wake detection, gyroscope calibration, magnetometer calibration, game rotation vector detection, gravity or linear acceleration detection, persistent stationary detection, device orientation detection, and/or activity recognition.

Additionally, or alternatively, the context component 320 may execute algorithms to evaluate information gathered by other on-device sources 310, either alone or in combination with the information gathered by the physical sensors. For example, in some aspects, the context component 320 may evaluate information gathered by connectivity sources to track connectivity quality, infer general location trends, determine network speeds and latencies, identify data usage patterns, identify frequently used networks, detect congestion, and/or identify connection patterns.

Additionally, or alternatively, the context component 320 may evaluate information gathered by other on-device sources 310 to identify commonly visited locations or travel patterns, to create or identify geo-fences or virtual boundaries for location-based alerts or actions, to detect a device interaction type (e.g., a user is likely watching a video when the user is not touching the device while holding the device in landscape, or likely playing a game when the user is frequently tapping with two hands), to detect gestures or identify one or more people that the user is spending time with based on camera inputs, and/or to identify a setting associated with a user location (e.g., a restaurant, home, work, or the like) based on audio inputs, among other examples.

Accordingly, as shown in FIG. 3, the instantaneous context and metadata may be provided from the context component 320 to a personal knowledge graph component 340. Additionally, as further shown in FIG. 3, the personal knowledge graph component 340 may receive inputs from one or more external sources 330 (e.g., other than an electronic device that includes the on-device sources 310 and performs the on-device personalization described herein). For example, as shown in FIG. 3, the external sources 330 may include other devices associated with a user, such as a smartwatch, a laptop computer, a smartphone, smart eyeglasses or other wearables, or the like. In some aspects, the external sources 330 may include respective on-device sources and/or components that can evaluate information gathered by the respective on-device sources to generate additional instantaneous context and metadata associated with the user in a similar manner as described for the on-device sources 310 and context component 320. Accordingly, as described herein, the personal knowledge graph component 340 may use the context information and metadata received from the local context component 320 and the external sources 330 to generate a personal knowledge graph that provides a structured representation to summarize attributes associated with a user.

As shown in FIG. 3, the personal knowledge graph component 340 may include a state space mapping and graph neural network (GNN) component 342, a context repository 344, and an attribute repository 346. For example, the context information and metadata received from the local context component 320 and the external sources 330 may be generated asynchronously, and the state space mapping and GNN component 342 may synchronize the context information and metadata received from the local context component 320 and the external sources 330 into a tabular format that can be consumed by one or more downstream applications. For example, the state space mapping and GNN component 342 may tabularize the context information and the metadata received from the local context component 320 and the external sources 330 into a frame-by-frame format, where each frame is associated with a timestamp and a set of observations associated with the timestamp. For example, the set of observations associated with a particular frame may include one or more features related to an instantaneous context or metadata feature, such as a motion state, an activity state, a location, an on-off body status, a setting, a transportation mode, a device orientation, a connectivity status, and/or another suitable attribute or feature that was observed at a particular point in time.

Accordingly, after the instantaneous context and metadata has been tabularized and synchronized by the state space mapping and GNN component 342, the information may be stored in the context repository 344 that provides a historical state space. In some aspects, the context repository 344 may store the historical state space over a configurable time period, such as a one-month history or a six-month history, to ensure that the historical state space reflects current patterns associated with the user. Additionally, or alternatively, the context repository 344 may store the historical state space or certain attributes associated with the historical state space over a longer time period, to reflect permanent attributes associated with the user or attributes that are unlikely to change significantly over time. Furthermore, as shown, the personal knowledge graph component 340 includes the attribute repository 346, which may be configured to store specific subsets of the attributes that are captured in the context repository 344 for one or more downstream applications. For example, one or more downstream applications that provide or leverage on-device personalization may be registered with the personal knowledge graph component 340, and one or more attributes that are relevant or of interest to the one or more downstream applications may be extracted from the context repository 344 and organized within the attribute repository 346 for consumption by the appropriate downstream application(s).

As further shown in FIG. 3, the architecture 300 may include an inference scheduler 350, which may schedule and perform one or more inferencing tasks (e.g., using on-device AI/ML models and/or capabilities). For example, in some aspects, the inference scheduler 350 may schedule one or more inferencing tasks that are performed to determine a user state and/or predict a user intent that may be relevant to a downstream application, and the output from the one or more inferencing tasks may be delivered to the downstream application (e.g., in response to a request or query from the downstream application, or according to an automated schedule or event-based trigger associated with the downstream application). Additionally, or alternatively, the inference scheduler 350 may schedule the one or more inferencing tasks to learn attributes associated with the user and further develop the personal knowledge graph captured in the context repository 344 and/or the attribute repository 346.

As indicated above, FIG. 3 is provided as an example. Other examples may differ from what is described in connection with FIG. 3.

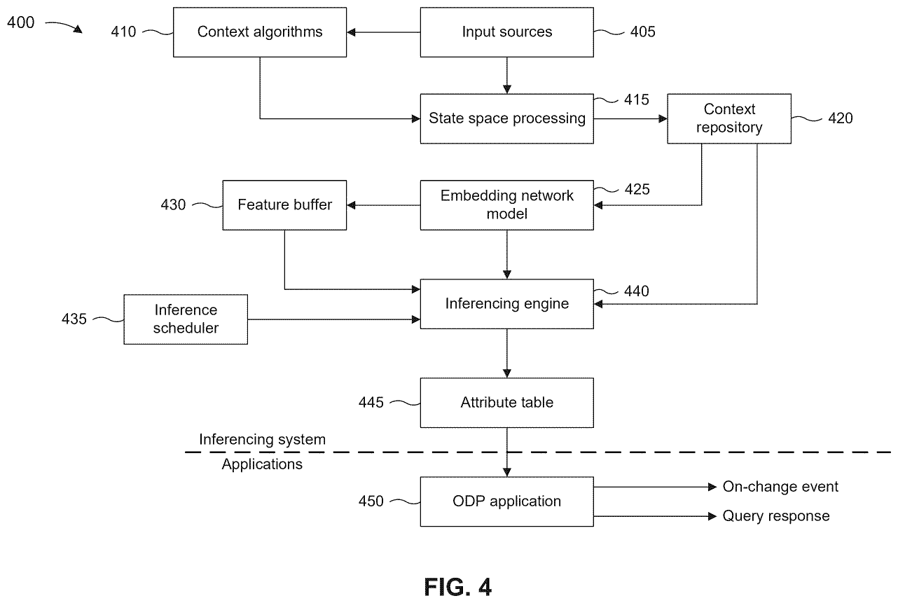

FIG. 4 is a diagram illustrating an example inferencing flow 400 that may support on-device personalization based on a detected user state and a predicted user intent, in accordance with the present disclosure. As shown in FIG. 4, the inferencing flow 400 includes various operations that may be performed by an inferencing system, such as a low-power AI/ML system associated with an electronic device or an ODP component that performs power-optimized inferencing using one or more AI/ML models that are stored locally on an electronic device using measurements, location information, and/or other information input from one or more on-device sources (e.g., one or more physical sensors and/or other suitable sources). In this way, user-specific data such as browsing histories, application usage patterns, preferences, and/or sensor data are stored and processed locally, which may increase privacy and security by minimizing exposure of personal information. Furthermore, by performing the inferencing flow 400 locally on an electronic device, some aspects described herein may improve latency and response times for on-device personalization, may enable federated learning where AI/ML models may be trained collaboratively across multiple devices and updated locally without transferring user data to a shared resource such as a central server, may enable AI/ML model adaptation based on changes to user behaviors and/or preferences over time, and/or improved energy efficiency by accelerating AI/ML model execution using specialized hardware (e.g., neural processing units or graphics processing units) and/or quantization, pruning, and/or low-power inference techniques.

For example, as shown by reference number 405, the inferencing flow 400 may include obtaining sensor data, location information, connectivity information, environmental information, and/or other suitable inputs from one or more input sources. For example, as described above with reference to FIG. 3, the one or more input sources may include on-device input sources such as a sensor system that includes various sensors, one or more connectivity sources (e.g., for obtaining parameters related to WWAN, WLAN, and/or WPAN communication), and/or other suitable on-device sources (e.g., one or more cameras, touchscreens, microphones, or the like). In addition, the one or more input sources may include one or more external sources, such as a smartphone, laptop computer, desktop computer, smartwatch, and/or other suitable devices associated with a user of the electronic device.

As shown by reference number 410, the inferencing flow 400 may include executing one or more context algorithms to evaluate the information obtained from the various input sources. For example, the information obtained from the various input sources may be analyzed in real-time using one or more context algorithms to determine an instantaneous context and related metadata associated with the electronic device. For example, in some aspects, the one or more context algorithms may be executed on the electronic device, and may be used for motion detection (e.g., absolute, relative, and/or significant motion detection), a pedometer, step detection, tilt detection, tilt-to-wake detection, gyroscope calibration, magnetometer calibration, game rotation vector detection, gravity or linear acceleration detection, persistent stationary detection, device orientation detection, and/or activity recognition. Additionally, or alternatively, the context algorithms may be executed to monitor data usage associated with certain applications or times, identify user routines, infer general location trends, determine network speeds and latencies, identify data usage patterns, identify frequently used networks, detect congestion, and/or identify connection patterns, among other examples.

As further shown by reference number 415, the inferencing flow 400 may include state space processing, which may be performed based on the instantaneous context and metadata obtained from the one or more context algorithms and the raw observations obtained from the one or more input sources. For example, as described herein, the instantaneous context and metadata obtained from the one or more context algorithms and the raw observations obtained from the one or more input sources may be generated asynchronously, and the state space processing may be performed to synchronize the asynchronously generated context information, metadata, and raw observations into a format that can be consumed by one or more downstream applications. For example, the state space processing may generate one or more frames, which are each associated with a timestamp and a set of observations associated with the timestamp. For example, the set of observations associated with a particular frame may include one or more features related to an instantaneous context or metadata feature, such as a motion state, an activity state, a location, an on-off body status, a setting, a transportation mode, a gait, a setting, a device orientation, a connectivity status, and/or another suitable attribute or feature observed at a particular point in time.

As further shown by reference number 420, the inferencing flow 400 may include storing the state space processing information in a context repository. For example, the state space processing information may be stored in the context repository to provide a historical state space over a configurable time period, such as one month, six months, or another suitable time period. Additionally, or alternatively, the context repository may store the historical state space or certain attributes associated with the historical state space over a longer time period, to reflect permanent attributes associated with the user or attributes that are unlikely to change significantly over time.

As further shown by reference number 425, the inferencing flow 400 may include executing an embedding network model, where the embedding network model may use AI/ML capabilities or AI/ML models to process a subset of the state space information represented in the context repository. For example, one or more downstream applications that provide or leverage on-device personalization may be registered with the embedding network model, and one or more attributes that are relevant or of interest to the one or more downstream applications may be extracted from the context repository and provided to the embedding network model for further processing. For example, the embedding network model may identify and analyze relevant features that are represented in the context repository to extract features that represent spatial and/or temporal attention associated with a user over an observation window, which may be a configurable time period (e.g., a few hours, one day, one week, or another suitable time period). As further shown by reference number 430, the inference flow 400 may include storing the features that represent the spatial and/or temporal attention associated with the user over the observation window in a feature buffer, such that the features associated with the observation window can be evaluated using an inferencing engine to detect a user state and/or a user intent at a current time, and/or to predict a user state and/or a user intent at a future time.

For example, as further shown by reference number 435, the inferencing flow 400 may include scheduling one or more inferencing tasks (e.g., classification tasks and/or prediction tasks, using on-device AI/ML models and/or capabilities, where the classification tasks and/or prediction tasks may depend on one or more target attributes of interest to one or more downstream applications). For example, in some aspects, the one or more inferencing tasks may be scheduled to periodically detect (or classify) a current user state and/or a current user intent, and/or to predict a user state and/or a user intent at a future time, where the user state and user intent may be relevant to a downstream application. Additionally, or alternatively, the one or more inferencing tasks may be scheduled to occur in response to a request or a query from a downstream application, or according to an automated schedule or an event-based trigger associated with a downstream application. Accordingly, as shown by reference number 440, the inferencing flow 400 may include executing the inferencing engine to detect (or classify) the user state and/or the user intent at a current time, and/or to predict the user state and/or the user intent at a future time, based on the schedule. For example, in some aspects, the inferencing engine may use on-device AI/ML models and/or capabilities to detect the user state and/or the user intent at the current time, and/or to predict the user state and/or the user intent at the future time based on the user knowledge maintained in the context repository and the feature buffer that includes frame-by-frame observations over an observation window, which details specific features or attributes that are relevant or of interest to one or more downstream applications. In some aspects, the observation window may have a configurable size, which may be configurable or defined according to the type of prediction to be made. For example, the observation window may generally have a length that is sufficient to provide a reliable prediction of the future context leveraged by a service (e.g., associated with one or more downstream applications), and the length or size of the window (e.g., the number of frames included in the observation window) may be adaptive to the inferencing task to be efficient and avoid algorithm confusion. As further shown by reference number 445, the inferencing flow 400 may include storing the inferred user state and/or user intent in an attribute table. For example, the features or attributes represented in the attribute table may include an age, a location type (e.g., home, office, or travel), an interest (e.g., travel or exercise), an activity level, an exercise intensity, a current activity, a transportation mode, or the like.

As further shown by reference number 450, the inferencing flow 400 may include providing the inferred and/or predicted user state and the inferred and/or predicted user intent to an ODP application. For example, in some aspects, the user state and/or user intent information may be provided to an ODP application that has registered to receive updates for events related to changes associated with the user state and/or the user intent, and/or events related to the user state and/or the user intent corresponding to a target user state and/or a target user intent. Additionally, or alternatively, the user state and/or user intent information may be provided to the ODP application in response to a query or request from the ODP application. In this way, the user state and/or user intent information may be used by the downstream ODP application for any suitable use case. For example, in some aspects, the user state and/or user intent information may be used for a location-based personalization use case, where an application may perform certain actions when a user is in proximity to a specific location and/or a certain place where the user typically spends time (e.g., silencing notifications when the user is at work and suggesting music to play when the user is commuting). In other examples, the user state and/or user intent information may be used for various other use cases, such as requesting a service, generating a reminder, customizing device settings, adapting a user interface, or performing another suitable personalization action or set of personalization actions based on time-of-day, a behavioral pattern, a recognized activity, a contextual wake word, user attention, user emotion or mood, or to request a designated driver service, as described herein.

As indicated above, FIG. 4 is provided as an example. Other examples may differ from what is described in connection with FIG. 4.

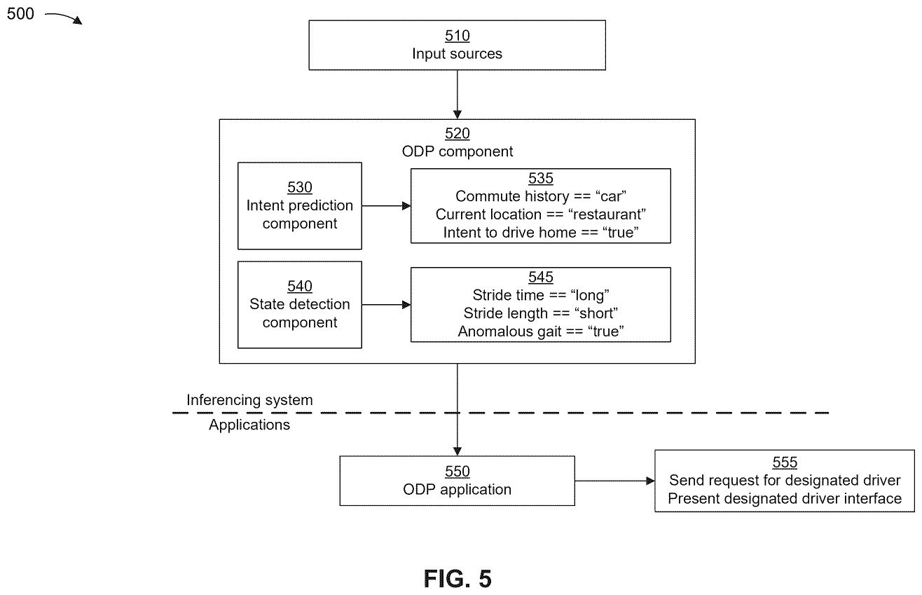

FIG. 5 is a diagram illustrating an example use case 500 associated with an inferencing system that may support on-device personalization based on a detected user state and a predicted user intent, in accordance with the present disclosure. In particular, the example use case 500 illustrated in FIG. 5 may be used to provide on-device personalization for an application that facilitates a designated driver service for a user that may be intoxicated or impaired (e.g., the user cannot drive home) or a user that is otherwise unable to drive (e.g., the user may have suffered an injury or fallen ill, and may need a driver to take the user home or obtain medical attention). For example, when a user is unable to drive, the designated driver service may allow the user to request a designated driver, who then travels to the user location and drives the user home in a personal vehicle. Accordingly, as described herein, the example use case 500 may utilize the on-device personalization techniques described herein to detect when a user is in an intoxicated or impaired state, or a state where the user is otherwise unable to drive, and the user is predicted to have the intent to travel in their vehicle.

For example, as shown in FIG. 5, an inferencing system may obtain sensor data, location information, connectivity information, environmental information, and/or other suitable inputs from one or more input sources 510. For example, as described in further detail herein, the one or more input sources 510 may include one or more on-device input sources such as a sensor system that includes various sensors, such as an inertial measurement unit (IMU) (e.g., including an accelerometer, gyroscope, magnetometer, and/or other sensors), a temperature sensor, a proximity sensor, an ambient light sensor, a pressure sensor, a humidity sensor, an ambient temperature sensor, a Hall sensor, and/or a capacitive proximity sensor. In addition, the input sources 510 may include one or more on-device connectivity sources (e.g., for obtaining parameters related to WWAN, WLAN, and/or WPAN communication), cameras, touchscreens, microphones, or the like, and one or more external sources, such as a smartphone, laptop computer, desktop computer, smartwatch, and/or other suitable devices associated with a user of an electronic device that includes the inference system.

As further shown in FIG. 5, the inputs from the one or more input sources 510 may be provided to an ODP component 520, which may be configured to generate one or more attributes or features associated with a user state and/or user intent that is relevant to the application associated with the designated driver service. For example, in some aspects, the application associated with the designated driver service may register with the inferencing system to receive information associated with a user state that corresponds to an impaired ability to drive (e.g., the user is intoxicated, injured, ill, or the like) and a user intent that corresponds to an intent to travel in a personal vehicle that is at or near a current location of the user. Accordingly, as described elsewhere herein, the inferencing system may execute one or more context algorithms to evaluate the information obtained from the various input sources 510 in real-time using one or more context algorithms to determine an instantaneous context and related metadata associated with the electronic device, which may be stored in a context repository that relates to a profile or attributes associated with a user that are learned over time. Accordingly, information related to the long-term history associated with the user may be provided to the ODP component 520, along with a subset of the features that may be indicative of the user state and/or user intent over an observation window.

As further shown in FIG. 5, the ODP component 520 may include an intent prediction component 530 that may predict the intent of the user at a future time based on a set of observations obtained during the observation window. For example, in some aspects, the observations that are obtained during the observation window may each include one or more frames that indicate features relevant to the target user intent, which is whether the user has the intent to travel home in their personal vehicle in the example use case 500 related to the designated driver service. For example, in some aspects, each frame may include features, attributes, or other information that may be indicative of a transportation mode, such as sensor context indicating a motion state (e.g., speed, angular rotations, or the like) corresponding to travel in a car, a train, or a subway, or a different vehicle type. In another example, features indicative of a transportation mode may include connectivity context such as whether the user connected a device such as a smartphone to an infotainment system in their personal vehicle, audio environment context indicating noise patterns or acoustics associated with a particular setting (e.g., a vehicle, a restaurant, a stadium, or the like), sensor context such as proximity to other humans (e.g., passengers in a vehicle), location context such as changes in location according to a pattern indicative of a transportation mode, and/or camera context such as a background when a facial recognition was performed, among other examples. Furthermore, the frames that are obtained during the observation window may include any other suitable parameters or set of parameters that may be relevant to determining whether the user has the intent to drive or travel in their personal vehicle.

Accordingly, the intent prediction component 530 may predict the user intent at a future time, or during a future forecasting window (e.g., the next few hours), based on a set of ground truth observations that are obtained during an observation window. For example, as shown by reference number 535, the intent prediction component 530 may predict that the user has the intent to drive home based on the ground truth observations indicating that the user traveled in their personal car to a current location where alcohol is commonly served (e.g., a restaurant or a bar). As described herein, although FIG. 5 illustrates an example where the intent prediction component 530 predicts that the user has the intent to drive home based on the ground truth observations indicating that the user traveled in their personal car to a location where alcohol is served, the intent prediction component 530 may predict the user intent with respect to driving based on any suitable feature, attribute, or other observation during the observation window (e.g., observations indicating that the user is walking toward the location where their car was parked) and the personal knowledge graph that summarizes the attributes associated with the user (e.g., a history of driving home after visiting restaurants).

As further shown in FIG. 5, the ODP component 520 may include a state detection component 540 that may detect the state of the user at a current time based on the set of observations obtained during the observation window. For example, in some aspects, the observations that are obtained during the observation window may include features relevant to determining whether the user in a state where the user may be unable to drive, such as an intoxicated or impaired state. For example, in some aspects, the features relevant to determining whether the user is able or unable to drive may include features related to a user gait, such as a stride length, a stride time, and/or a stride velocity. In another example, features relevant to determining whether the user is able or unable to drive may include the current location or recent location history of the user (e.g., whether the user is in a location or has recently been in a location where alcohol is served). Furthermore, the frames that are obtained during the observation window may include any other suitable parameters or set of parameters that may be relevant to determining whether the user is able or unable to drive.

Accordingly, the state detection component 540 may detect the user state at the current time based on the set of ground truth observations that are obtained during an observation window. For example, as shown by reference number 545, the state detection component 540 may detect that the user is intoxicated or impaired based on the sensor inputs indicating a user gait with a stride time that is longer than a typical stride time when the user is in a sober state, a stride length that is shorter than a typical stride length when the user is in a sober state, and/or a stride velocity that is slower than a typical stride velocity when the user is in a sober state. Additionally, or alternatively, the state detection component 540 may detect that the user is intoxicated or impaired based on IMU measurements or other sensor inputs indicating that the user is exhibiting poor coordination, uncertain starts and stops, unequal steps, lateral deviations, or the like. Furthermore, although FIG. 5 illustrates an example where the state detection component 540 detects whether the user is intoxicated or impaired based on ground truth observations indicating gait parameters, the state detection component 540 may classify the user state (e.g., impaired, sober, injured, unable to drive, able to drive, or the like) based on any suitable feature, attribute, or other observation during the observation window and the personal knowledge graph that summarizes the user attributes.

As further shown in FIG. 5, the ODP component 520 may provide, to an ODP application 550 associated with the designated driver service, information that indicates the targeted user state detected at the current time (e.g., ability or inability to drive) and the targeted user intent predicted in the future time window (e.g., intent to drive or to not drive, or an intent to travel or not travel in a personal vehicle). For example, as described herein, the targeted user state at the current time and the targeted user intent predicted in the future time window may be provided to the ODP application 550 based on a request or query from the ODP application 550 or based on the ODP application 550 registering to receive notifications when there is an event related to the targeted user state and/or the targeted user intent. Accordingly, as described herein, the ODP application may perform one or more appropriate on-device personalization actions based on whether the user state detected at the current time and the user intent predicted in the future time window satisfy one or more conditions associated with the designated driver service. For example, as shown by reference number 555, the ODP application 550 may automatically send a message over a network to request the designated driver service based on the user being in an intoxicated or impaired state and having the intent to drive. Additionally, or alternatively, the ODP application 550 may present an interface with an option to request the designated driver service or to override a request for the designated driver service.

As indicated above, FIG. 5 is provided as an example. Other examples may differ from what is described in connection with FIG. 5.

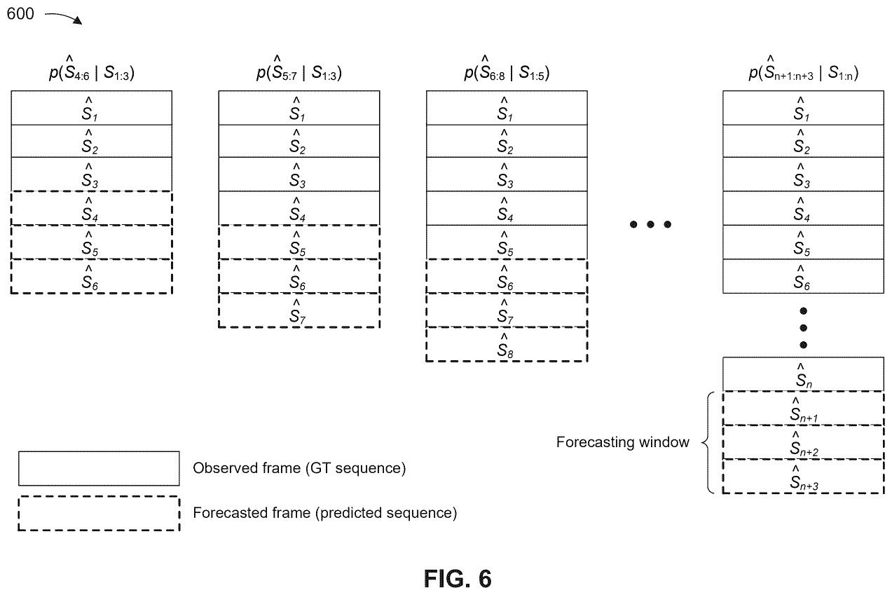

FIG. 6 is a diagram illustrating an example 600 of multi-step prediction based on a set of ground truth observations, in accordance with the present disclosure. For example, as described herein, an inferencing system may asynchronously receive information that relates to instantaneous context and metadata associated with one or more observation sources, which may include any suitable combination of on-device sources and/or external sources. Furthermore, when performing a predictive inferencing task (e.g., user state prediction or user intent prediction), the inferencing system may tabularize the asynchronously received observations to generate one or more frames that each include a set of features relevant to one or more target variables (e.g., a user state or a user intent, or a more granular target variable, such as a transportation mode, a current location, and/or a gait in a designated driver service use case). Accordingly, the frames that include features related to actual (ground truth) observations may correspond to observed frames during an observation window, which the inferencing system may use to make predictions for one or more frames in a future forecasting window. In some aspects, as described herein, the future forecasting window may have a configurable size based on the target variable to be predicted. For example, for a designated driver use case, the future forecasting window for the intent to drive prediction may be the next one hour or few hours. In general, the quality or accuracy of predictions may be worse at the later part of the future forecasting window than the earlier part of the future forecasting window. Accordingly, the length (e.g., number of frames) associated with the future forecasting window may be configured based on the particular target variable to be predicted.

For example, referring to FIG. 6, the inferencing system may initially obtain a set of ground truth observations over an observation window that includes three observed frames, denoted S_{1:3}, and the inferencing system may use the set of ground truth observations to predict the corresponding features in a future forecasting window that includes three forecasted frames, denoted Ŝ_{4:6}. As time progresses, the inferencing system may use additional observations to generate predictions for the future forecasting window and to evaluate the accuracy of AI/ML beliefs that were used for earlier predictions. For example, after obtaining a fourth observed frame, the observation window includes four observed frames, denoted S_{1:4}, which are used to predict the corresponding features in the future forecasting window that includes forecasted frames Ŝ_{5:7}. Furthermore, the inferencing system may use the ground truth observations in observed frame S₄ to confirm, modify, or otherwise update an AI/ML belief associated with the previous prediction for forecasted frame Ŝ₄, and the same process may be performed over time to refine the predictions for the future forecasting window and/or generate feedback to train or retrain the AI/ML models that were used to generate the predictions for the future forecasting window.

As indicated above, FIG. 6 is provided as an example. Other examples may differ from what is described in connection with FIG. 6.

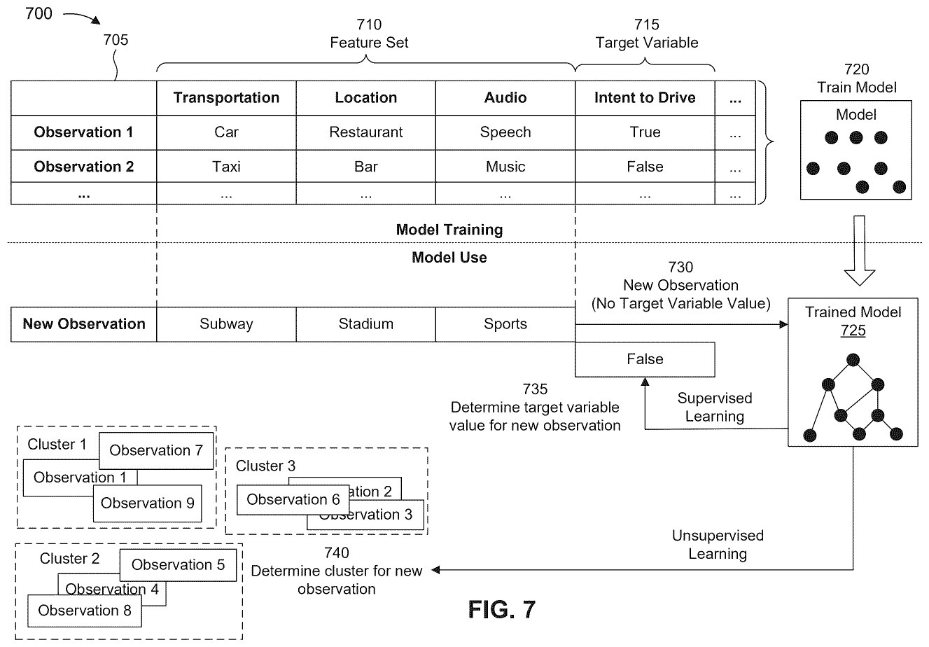

FIG. 7 is a diagram illustrating an example 700 associated with training and using an AI/ML model in connection with on-device personalization based on a detected user state and a predicted user intent, in accordance with the present disclosure. The AI/ML model training and usage described herein may be performed using an AI/ML system. The AI/ML system may include or may be included in a computing device, a server, a cloud computing environment, or the like, such as the electronic device 110 and/or the inferencing system implementing architecture 300, inferencing flow 400, and/or use case 500, as described in more detail elsewhere herein.

As shown by reference number 705, an AI/ML model may be trained using a set of observations. The set of observations may be obtained from training data (e.g., historical data), such as data gathered during one or more processes described herein. In some implementations, the AI/ML system may receive the set of observations (e.g., as input) from one or more on-device sources (e.g., one or more sensors, one or more communication interfaces, a location detection system, a touch screen, a camera, an audio system, a microphone, or the like) and/or one or more external sources (e.g., a smartphone, a laptop computer, a smartwatch, smart glasses, or the like), as described elsewhere herein.

As shown by reference number 710, the set of observations may include a feature set. The feature set may include a set of variables, and a variable may be referred to as a feature. A specific observation may include a set of variable values (or feature values) corresponding to the set of variables. In some implementations, the AI/ML system may determine variables for a set of observations and/or variable values for a specific observation based on input received from the on-device sources and/or the external sources. For example, the AI/ML system may identify a feature set (e.g., one or more features and/or feature values) by extracting the feature set from structured data, by performing natural language processing to extract the feature set from unstructured data, by performing noise filtering, data normalization, signal alignment, and/or other pre-processing to extract the feature set from sensor data, and/or by receiving input from an operator.

As an example, a feature set for a set of observations may include a first feature related to a transportation context, a second feature related to a location context, a third feature related to an audio context, and so on. As shown, for a first observation, the first feature may have a value of “car”, the second feature may have a value of “restaurant”, the third feature may have a value of “speech”, and so on. These features and feature values are provided as examples, and may differ in other examples. For example, the feature set may include one or more of the following features: motion type, exercise intensity, device usage, time, gait type, gesture, and/or any other suitable feature that may relate to one or more observations by an on-device source and/or an external source.

As shown by reference number 715, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 700, the target variable is “intent to drive”, which has a value of “true” for the first observation.

The feature set and target variable described above are provided as examples, and other examples may differ from what is described above. For example, for a target variable of “gait type”, the feature set may include stride time, stride length, stride velocity.

The target variable may represent a value that an AI/ML model is being trained to predict, and the feature set may represent the variables that are input to a trained AI/ML model to predict a value for the target variable. The set of observations may include target variable values so that the AI/ML model can be trained to recognize patterns in the feature set that lead to a target variable value. An AI/ML model that is trained to predict a target variable value may be referred to as a supervised learning model.

In some implementations, the AI/ML model may be trained on a set of observations that do not include a target variable. This may be referred to as an unsupervised learning model. In this case, the AI/ML model may learn patterns from the set of observations without labeling or supervision, and may provide output that indicates such patterns, such as by using clustering and/or association to identify related groups of items within the set of observations.

As shown by reference number 720, the AI/ML system may train an AI/ML model using the set of observations and using one or more AI/ML algorithms, such as a personal knowledge graph algorithm, a density peaks clustering algorithm, a curvature convex defects algorithm, a regression algorithm, a decision tree algorithm, a neural network algorithm, a k-nearest neighbor algorithm, a support vector machine algorithm, or the like. For example, a personal knowledge graph algorithm may be used to learn demographics, habits, interests, and/or other attributes about a user over time, and to organize the personal knowledge about the user into a structure that summarizes key attributes in a manner that can be used to enhance downstream applications via personalization. After training, the AI/ML system may store the AI/ML model as a trained AI/ML model 725 to be used to analyze new observations.

As shown by reference number 730, the AI/ML system may apply the trained AI/ML model 725 to a new observation, such as by receiving a new observation and inputting the new observation to the trained AI/ML model 725. As shown, the new observation may include a first feature of “subway” as a transportation context, a second feature of “stadium” as a location context, a third feature of “sports” as an audio context, and so on, as an example. The AI/ML system may apply the trained AI/ML model 725 to the new observation to generate an output (e.g., a result). The type of output may depend on the type of AI/ML model and/or the type of AI/ML task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained AI/ML model 725 may predict a value of “false” for the target variable of “intent to drive” for the new observation (e.g., based on the user traveling to a sporting event in a stadium via the subway, rather than in their personal car or vehicle), as shown by reference number 735. Based on this prediction, the AI/ML system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to walk to a subway station that tends to be less busy after a sporting event. The first automated action may include, for example, providing walking directions to a subway station.

As another example, if the AI/ML system were to predict a value of “true” for the target variable of “intent to drive”, then the AI/ML system may provide a second (e.g., different) recommendation (e.g., a recommendation to request a designated driver service if a detected or inferred user state is impaired or intoxicated) and/or may perform or cause performance of a second (e.g., different) automated action (e.g., sending a request over a network to request a designated driver service if a detected or inferred user state is impaired or intoxicated).

In some implementations, the trained AI/ML model 725 may classify (e.g., cluster) the new observation in a cluster, as shown by reference number 740. The observations within a cluster may have a threshold degree of similarity. As an example, if the AI/ML system classifies the new observation in a first cluster (e.g., alternative travel modes), then the AI/ML system may provide a first recommendation, such as the first recommendation described above. Additionally, or alternatively, the AI/ML system may perform a first automated action and/or may cause a first automated action to be performed (e.g., by instructing another device to perform the automated action) based on classifying the new observation in the first cluster, such as the first automated action described above.

As another example, if the AI/ML system were to classify the new observation in a second cluster (e.g., travel in personal vehicle to location where drinking alcohol commonly occurs), then the AI/ML system may provide a second (e.g., different) recommendation (e.g., requesting a designated driver service) and/or may perform or cause performance of a second (e.g., different) automated action, such as evaluating or inferring whether the user is in an impaired, intoxicated, or sober state, and sending a message over a network to request a designated driver service if the user is impaired or intoxicated.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained AI/ML model 725 may be re-trained using feedback information. For example, feedback may be provided to the AI/ML model. The feedback may be associated with actions performed based on the recommendations provided by the trained AI/ML model 725 and/or automated actions performed, or caused, by the trained AI/ML model 725. In other words, the recommendations and/or actions output by the trained AI/ML model 725 may be used as inputs to re-train the AI/ML model (e.g., a feedback loop may be used to train and/or update the AI/ML model). For example, the feedback information may include the user cancelling or overriding a request for a designated driver service (e.g., based on the user not being impaired or intoxicated) or information indicating that a designated driver arrived at the location of the user and drove the user home in their personal vehicle.

In this way, the AI/ML system may apply a rigorous and automated process to predict a user intent and/or detect a user state based on observations obtained from one or more on-device sources and/or one or more external sources. The AI/ML system may enable recognition and/or identification of tens, hundreds, thousands, or millions of features and/or feature values for tens, hundreds, thousands, or millions of observations, thereby increasing accuracy and consistency and reducing delay associated with detecting a user state and/or predicting a user intent relative to requiring computing resources to be allocated for tens, hundreds, or thousands of operators to manually detect a user state and/or predict a user intent using the features or feature values.

As indicated above, FIG. 7 is provided as an example. Other examples may differ from what is described in connection with FIG. 7.

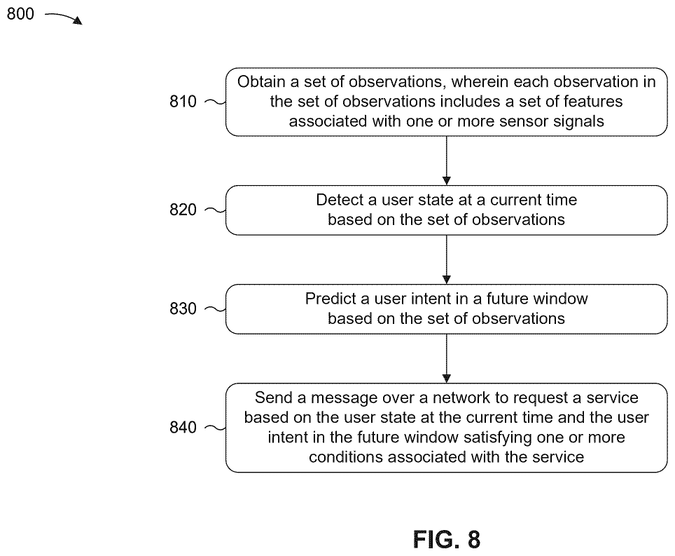

FIG. 8 is a flowchart of an example process 800 associated with on-device personalization based on a detected user state and a predicted user intent, in accordance with the present disclosure. In some aspects, one or more process blocks of FIG. 8 are performed by a device (e.g., electronic device 110, device 200, or the like). In some aspects, one or more process blocks of FIG. 8 are performed by another device or a group of devices separate from or including the device, such as a network node (e.g., network node 120), a remote device (e.g., service provider device 130), an inferencing system (e.g., an inferencing system associated with architecture 300, an inferencing system implementing inferencing flow 400, and/or an inferencing system implementing use case500), and/or an AI/ML system. Additionally, or alternatively, one or more process blocks of FIG. 8 may be performed by one or more components of device 200 (e.g., processor 210, memory 215, input component 220, output component 225, communication component 230, sensor system 235, and/or personalization component 240), one or more components of inferencing system associated with architecture 300 (e.g., context component 320, personal knowledge graph component 340, and/or inference scheduler 350), one or more components of an inferencing system implementing inferencing flow 400, and/or one or more components of an inferencing system implementing use case 500 (e.g., input sources 510, ODP component 520, and/or ODP application 550), among other examples.

As shown in FIG. 8, process 800 may include obtaining a set of observations, wherein each observation in the set of observations includes a set of features associated with one or more sensor signals (block 810). For example, the device may obtain a set of observations, wherein each observation in the set of observations includes a set of features associated with one or more sensor signals, as described above.

As further shown in FIG. 8, process 800 may include detecting a user state at a current time based on the set of observations (block 820). For example, the device may detect a user state at a current time based on the set of observations, as described above.

As further shown in FIG. 8, process 800 may include predicting a user intent in a future window based on the set of observations (block 830). For example, the device may predict a user intent in a future window based on the set of observations, as described above.

As further shown in FIG. 8, process 800 may include sending a message over a network to request a service based on the user state at the current time and the user intent in the future window satisfying one or more conditions associated with the service (block 840). For example, the device may send a message over a network to request a service based on the user state at the current time and the user intent in the future window satisfying one or more conditions associated with the service, as described above.

Process 800 may include additional aspects, such as any single aspect or any combination of aspects described below and/or in connection with one or more other processes described elsewhere herein.

In a first aspect, the one or more conditions associated with the service include the user state at the current time corresponding to a targeted user state associated with the service and the user intent in the future window corresponding to a targeted activity associated with the targeted user state.

In a second aspect, alone or in combination with the first aspect, sending the message to request the service is further based on the user state at the current time indicating that a user is impaired.

In a third aspect, alone or in combination with one or more of the first and second aspects, sending the message to request the service is further based on an application configuration that defines an event to trigger an automated request for the service when the one or more conditions are satisfied.

In a fourth aspect, alone or in combination with one or more of the first through third aspects, sending the message to request the service is further based on an application query to determine whether the one or more conditions associated with the service are satisfied.

In a fifth aspect, alone or in combination with one or more of the first through fourth aspects, process 800 includes presenting an option to request the service based on the user state at the current time and the user intent in the future window, wherein sending the message to request the service is further based on a user selecting the option to request the service.

In a sixth aspect, alone or in combination with one or more of the first through fifth aspects, process 800 includes obtaining user context information that is based on a set of historical observations associated with one or more sensor signals, wherein detecting the user state at the current time is further based on the user context information, and predicting the user intent in the future window is further based on the user context information.

In a seventh aspect, alone or in combination with one or more of the first through sixth aspects, the future window has a duration that is based on a targeted user intent to be predicted.

In an eighth aspect, alone or in combination with one or more of the first through seventh aspects, process 800 includes obtaining one or more additional observations, wherein the one or more additional observations each include a set of features associated with one or more sensor signals, and generating information to confirm an AI/ML belief associated with the one or more conditions based on the one or more additional observations indicating no change to the user state and no change to the user intent.

In a ninth aspect, alone or in combination with one or more of the first through eighth aspects, process 800 includes obtaining one or more additional observations, wherein the one or more additional observations each include a set of features associated with one or more sensor signals, and generating information to change an AI/ML belief associated with the one or more conditions based on the one or more additional observations indicating a change to one or more of the user state or the user intent.

Although FIG. 8 shows example blocks of process 800, in some aspects, process 800 includes additional blocks, fewer blocks, different blocks, or differently arranged blocks than those depicted in FIG. 8. Additionally, or alternatively, two or more of the blocks of process 800 may be performed in parallel.

The following provides an overview of some Aspects of the present disclosure:

Aspect 1: A method for on-device personalization performed by a device, comprising: obtaining a set of observations, wherein each observation in the set of observations includes a set of features associated with one or more sensor signals; detecting a user state at a current time based on the set of observations; predicting a user intent in a future window based on the set of observations; and sending a message over a network to request a service based on the user state at the current time and the user intent in the future window satisfying one or more conditions associated with the service.

Aspect 2: The method of Aspect 1, wherein the one or more conditions associated with the service include the user state at the current time corresponding to a targeted user state associated with the service and the user intent in the future window corresponding to a targeted activity associated with the targeted user state.

Aspect 3: The method of any of Aspects 1-2, wherein sending the message to request the service is further based on the user state at the current time indicating that a user is impaired.

Aspect 4: The method of any of Aspects 1-3, wherein sending the message to request the service is further based on an application configuration that defines an event to trigger an automated request for the service when the one or more conditions are satisfied.

Aspect 5: The method of any of Aspects 1-4, wherein sending the message to request the service is further based on an application query to determine whether the one or more conditions associated with the service are satisfied.

Aspect 6: The method of any of Aspects 1-5, further comprising: presenting an option to request the service based on the user state at the current time and the user intent in the future window, wherein sending the message to request the service is further based on a user selecting the option to request the service.

Aspect 7: The method of any of Aspects 1-6, further comprising: obtaining user context information that is based on a set of historical observations associated with one or more sensor signals, wherein: detecting the user state at the current time is further based on the user context information, and predicting the user intent in the future window is further based on the user context information.

Aspect 8: The method of any of Aspects 1-7, wherein the future window has a duration that is based on a targeted user intent to be predicted.

Aspect 9: The method of any of Aspects 1-8, further comprising: obtaining one or more additional observations, wherein the one or more additional observations each include a set of features associated with one or more sensor signals; and generating information to confirm an AI/ML belief associated with the one or more conditions based on the one or more additional observations indicating no change to the user state and no change to the user intent.

Aspect 10: The method of any of Aspects 1-9, further comprising: obtaining one or more additional observations, wherein the one or more additional observations each include a set of features associated with one or more sensor signals; and generating information to change an AI/ML belief associated with the one or more conditions based on the one or more additional observations indicating a change to one or more of the user state or the user intent.

Aspect 11: A device, comprising: one or more memories; and one or more processors, coupled to the one or more memories, configured to cause the device to: obtain a set of observations, wherein each observation in the set of observations includes a set of features associated with one or more sensor signals; detect a user state at a current time based on the set of observations; predict a user intent in a future window based on the set of observations; and send a message over a network to request a service based on the user state at the current time and the user intent in the future window satisfying one or more conditions associated with the service.

Aspect 12: The device of Aspect 11, wherein the one or more conditions associated with the service include the user state at the current time corresponding to a targeted user state associated with the service and the user intent in the future window corresponding to a targeted activity associated with the targeted user state.

Aspect 13: The device of any of Aspects 11-12, wherein the message to request the service is further based on the user state at the current time indicating that a user is impaired.

Aspect 14: The device of any of Aspects 11-13, wherein the message to request the service is based on an application configuration that defines an event to trigger an automated request for the service when the one or more conditions are satisfied.

Aspect 15: The device of any of Aspects 11-14, wherein the message to request the service is further based on an application query to determine whether the one or more conditions associated with the service are satisfied.

Aspect 16: The device of any of Aspects 11-15, wherein the one or more processors are further configured to cause the device to: present an option to request the service based on the user state at the current time and the user intent in the future window, wherein the message to request the service is further based on a user selecting the option to request the service.

Aspect 17: The device of any of Aspects 11-16, wherein the one or more processors are further configured to cause the device to: obtain user context information that is based on a set of historical observations associated with one or more sensor signals, wherein: the user state at the current time is further based on the user context information, and the user intent in the future window is further based on the user context information.

Aspect 18: The device of any of Aspects 11-17, wherein the future window has a duration that is based on a targeted user intent to be predicted.

Aspect 19: The device of any of Aspects 11-18, wherein the one or more processors are further configured to cause the device to: obtain one or more additional observations, wherein the one or more additional observations each include a set of features associated with one or more sensor signals; and generate information to update an AI/ML belief associated with the one or more conditions based on the one or more additional observations.

Aspect 20: A non-transitory computer-readable medium storing a set of instructions, the set of instructions comprising: one or more instructions that, when executed by one or more processors of a device, cause the device to: obtain a set of observations, wherein each observation in the set of observations includes a set of features associated with one or more sensor signals; detect a user state at a current time based on the set of observations; predict a user intent in a future window based on the set of observations; and send a message over a network to request a service based on the user state at the current time and the user intent in the future window satisfying one or more conditions associated with the service.

Aspect 21: A system configured to perform one or more operations recited in one or more of Aspects 1-20.

Aspect 22: An apparatus comprising means for performing one or more operations recited in one or more of Aspects 1-20.

Aspect 23: A non-transitory computer-readable medium storing a set of instructions, the set of instructions comprising one or more instructions that, when executed by a device, cause the device to perform one or more operations recited in one or more of Aspects 1-20.

Aspect 24: A computer program product comprising instructions or code for executing one or more operations recited in one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the terms “set” and “group” are intended to include one or more items and may be used interchangeably with “one or more. ” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method for on-device personalization performed by a device, comprising:
obtaining a set of observations, wherein each observation in the set of observations includes a set of features associated with one or more sensor signals;
detecting a user state at a current time based on the set of observations;
predicting a user intent in a future window based on the set of observations; and
sending a message over a network to request a service based on the user state at the current time and the user intent in the future window satisfying one or more conditions associated with the service.

2. The method of claim 1, wherein the one or more conditions associated with the service include the user state at the current time corresponding to a targeted user state associated with the service and the user intent in the future window corresponding to a targeted activity associated with the targeted user state.

3. The method of claim 1, wherein sending the message to request the service is further based on the user state at the current time indicating that a user is impaired.

4. The method of claim 1, wherein sending the message to request the service is further based on an application configuration that defines an event to trigger an automated request for the service when the one or more conditions are satisfied.

5. The method of claim 1, wherein sending the message to request the service is further based on an application query to determine whether the one or more conditions associated with the service are satisfied.

6. The method of claim 1, further comprising:
presenting an option to request the service based on the user state at the current time and the user intent in the future window, wherein sending the message to request the service is further based on a user selecting the option to request the service.

7. The method of claim 1, further comprising:
obtaining user context information that is based on a set of historical observations associated with one or more sensor signals, wherein:
detecting the user state at the current time is further based on the user context information, and
predicting the user intent in the future window is further based on the user context information.

8. The method of claim 1, wherein the future window has a duration that is based on a targeted user intent to be predicted.

9. The method of claim 1, further comprising:
obtaining one or more additional observations, wherein the one or more additional observations each include a set of features associated with one or more sensor signals; and
generating information to confirm an artificial intelligence or machine learning belief associated with the one or more conditions based on the one or more additional observations indicating no change to the user state and no change to the user intent.

10. The method of claim 1, further comprising:
obtaining one or more additional observations, wherein the one or more additional observations each include a set of features associated with one or more sensor signals; and
generating information to change an artificial intelligence or machine learning belief associated with the one or more conditions based on the one or more additional observations indicating a change to one or more of the user state or the user intent.

11. A device, comprising:
one or more memories; and
one or more processors, coupled to the one or more memories, configured to cause the device to:
obtain a set of observations, wherein each observation in the set of observations includes a set of features associated with one or more sensor signals;
detect a user state at a current time based on the set of observations;
predict a user intent in a future window based on the set of observations; and
send a message over a network to request a service based on the user state at the current time and the user intent in the future window satisfying one or more conditions associated with the service.

12. The device of claim 11, wherein the one or more conditions associated with the service include the user state at the current time corresponding to a targeted user state associated with the service and the user intent in the future window corresponding to a targeted activity associated with the targeted user state.

13. The device of claim 11, wherein the message to request the service is further based on the user state at the current time indicating that a user is impaired.

14. The device of claim 11, wherein the message to request the service is based on an application configuration that defines an event to trigger an automated request for the service when the one or more conditions are satisfied.

15. The device of claim 11, wherein the message to request the service is further based on an application query to determine whether the one or more conditions associated with the service are satisfied.

16. The device of claim 11, wherein the one or more processors are further configured to cause the device to:
present an option to request the service based on the user state at the current time and the user intent in the future window, wherein the message to request the service is further based on a user selecting the option to request the service.

17. The device of claim 11, wherein the one or more processors are further configured to cause the device to:
obtain user context information that is based on a set of historical observations associated with one or more sensor signals, wherein:
the user state at the current time is further based on the user context information, and
the user intent in the future window is further based on the user context information.

18. The device of claim 11, wherein the future window has a duration that is based on a targeted user intent to be predicted.

19. The device of claim 11, wherein the one or more processors are further configured to cause the device to:
obtain one or more additional observations, wherein the one or more additional observations each include a set of features associated with one or more sensor signals; and
generate information to update an artificial intelligence or machine learning belief associated with the one or more conditions based on the one or more additional observations.

20. A non-transitory computer-readable medium storing a set of instructions, the set of instructions comprising:
one or more instructions that, when executed by one or more processors of a device, cause the device to:
obtain a set of observations, wherein each observation in the set of observations includes a set of features associated with one or more sensor signals;
detect a user state at a current time based on the set of observations;
predict a user intent in a future window based on the set of observations; and
send a message over a network to request a service based on the user state at the current time and the user intent in the future window satisfying one or more conditions associated with the service.
